(19) United States
(12) Patent Application Publication
(10) Pub. No.: US 2026/0179503 A1
(43) Pub. Date: Jun. 25, 2026

(54) SYSTEM, METHOD, AND COMPUTER PROGRAM FOR GENERATING ASSESSMENT QUESTIONS AUTOMATICALLY

(71) Applicant: Udemy, Inc., San Francisco, CA (US)

(72) Inventors: Zeynep Balal, Istanbul (TR); Raka Dalal, Bengaluru, (IN); Gönenç Ercan, Ankara (TR); Asiye Tuba Özge, Ankara (TR); Onur Güngör, Istanbul (TR); John Taylor Willse, JR., Greensboro, NC (US)

(21) Appl. No.: 19/195,552

(22) Filed: Apr. 30, 2025

(30) Foreign Application Priority Data
Dec. 23, 2024 (TR) 2024/020163

(51) Int. Cl. G09B 7/06

(52) U.S. Cl. CPC G09B 7/06

(57) ABSTRACT

Assessment questions are automatically generated by receiving input data related to a user-specified topic. A set of multiple-choice questions (MCQs) is generated based on the received input data using an AI model, and analyzed for errors using the AI model by detecting and discarding generated MCQs having problematic distractors, and ensuring compliance with formatting standards. The generated MCQs are evaluated for alignment with a user-specified learning objective and adherence to predefined quality criteria using an evaluation AI model. Any generated MCQs evaluated as rejected by the evaluation AI model are discarded. The system determines whether there are a target number of generated MCQs evaluated as accepted by the evaluation AI model. In response to having less than the target number of generated MCQs evaluated as accepted, the generation, analysis, and evaluation processes are repeated until there are a target number of generated MCQs evaluated as accepted, which are then outputted.

### RELATED APPLICATIONS

In accordance with 35 USC 119(a), this application claims priority from Turkish Patent Application No. TR 2024/020163 filed with the Turkish Patent and Trademark Office (Turkpatent) on Dec. 23, 2024.

### BACKGROUND OF THE INVENTION

### 1. Field of the Invention

This invention relates generally to the education-technology industry and, more specifically, to systems and methods for generating assessment questions automatically.

### 2. Description of the Background Art

Question generation is a crucial facet of the education-technology industry. The ability for students to undertake numerous mock examinations significantly contributes to their preparedness for actual evaluations. This concept equally extends to instructors who create quizzes for their courses with an aim to determine their learners'comprehension levels. However, the conventional method of forming these questions has always relied on the expertise and knowledge of specific individuals who manually draft the questions, a process that is expensive and time-consuming compared to automated techniques.

The present system addresses these gaps, utilizing sophisticated computational processes to curtail the challenges associated with manual work. The artificial intelligence (AI) model is designed to generate a custom number of multiple-choice questions (MCQs), and includes the following components: the question stem, answer choices, feedback about the answer choices, and the correct answer. The MCQs are all based on a specific topic as selected by the user. The AI model takes as input a particular learning objective for accurate question generation. In certain embodiments, the AI model can initially generate the learning objective from a certain text (e.g., a section of a course) before proceeding to formulate the questions. Moreover, the system includes an evaluation AI model, which evaluates the quality of the generated questions to ascertain if they meet the necessary standards. The present solution reduces costs and enhances efficiency in question generation in the education-technology industry.

### SUMMARY OF THE DISCLOSURE

The present disclosure describes a system, method, and computer program for generating assessment questions automatically. The method is performed by a computer system that includes servers, storage systems, networks, operating systems, and databases.

The present disclosure describes a system and method designed to automatically generate MCQs using an AI model based on a user-specified topic, using the input of a learning objective. The goal of this system is to measure a learner's proficiency in a given subject through a dynamically-created assessment. The system also includes an evaluation AI model that gauges the quality of the generated MCQs and ensures they align with set standards. The system provides a practical tool for anyone wishing to create an endless array of questions on any topic, eliminating the need for manually curating questions.

In one embodiment, a method for generating assessment questions automatically comprises the following steps:
receiving input data related to a user-specified topic, wherein the input data comprises a user-specified learning objective;
generating a set of multiple-choice questions (MCQs) based on the received input data using an AI model;
analyzing the generated MCQs for errors using the AI model by:
   detecting and discarding generated MCQs having problematic distractors, wherein problematic distractors include distractors that do not satisfy length or difficulty criteria, and
   ensuring compliance with formatting standards;
evaluating the generated MCQs for alignment with the user-specified learning objective and adherence to predefined quality criteria using an evaluation AI model, wherein the generated MCQs are evaluated as accepted or rejected;
discarding any generated MCQs evaluated as rejected by the evaluation AI model;
determining whether there are a target number of generated MCQs evaluated as accepted by the evaluation AI model;
in response to having less than the target number of generated MCQs evaluated as accepted, repeating the generation, analysis, and evaluation processes until there are a target number of generated MCQs evaluated as accepted; and
outputting the target number of generated MCQs evaluated as accepted by the evaluation AI model.

### BRIEF DESCRIPTION OF THE DRAWINGS

FIG. 1 is a flowchart that illustrate a method, according to one embodiment, for generating assessment questions automatically.

FIG. 2 is a block diagram that illustrates an example system architecture and data flow according to one embodiment.

### DETAILED DESCRIPTION OF THE PREFERRED EMBODIMENTS

The present disclosure describes a system, method, and computer program for generating assessment questions automatically. The method is performed by a computer system that includes servers, storage systems, networks, operating systems, and databases (“the system”).

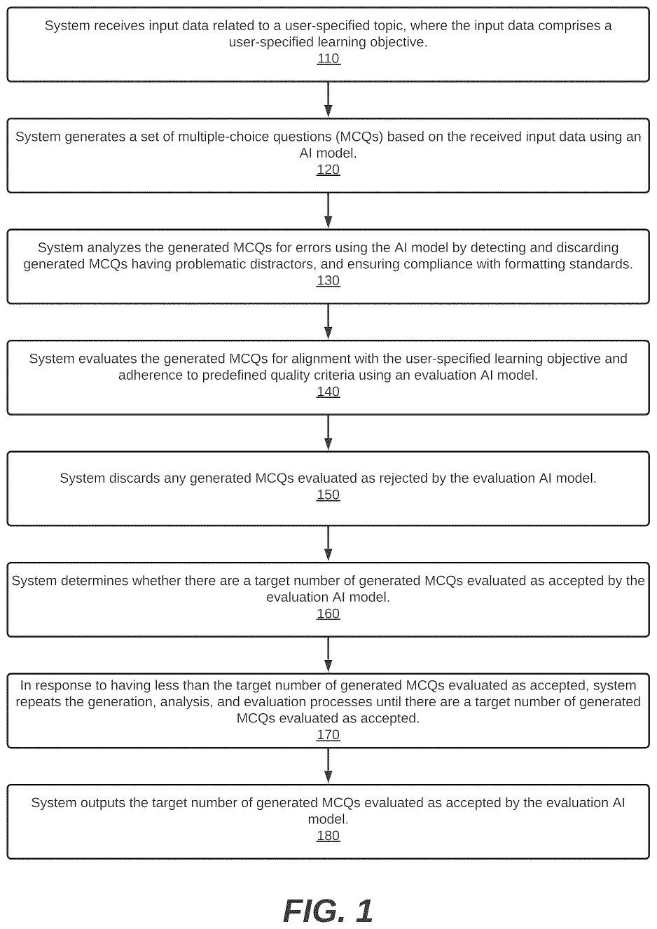

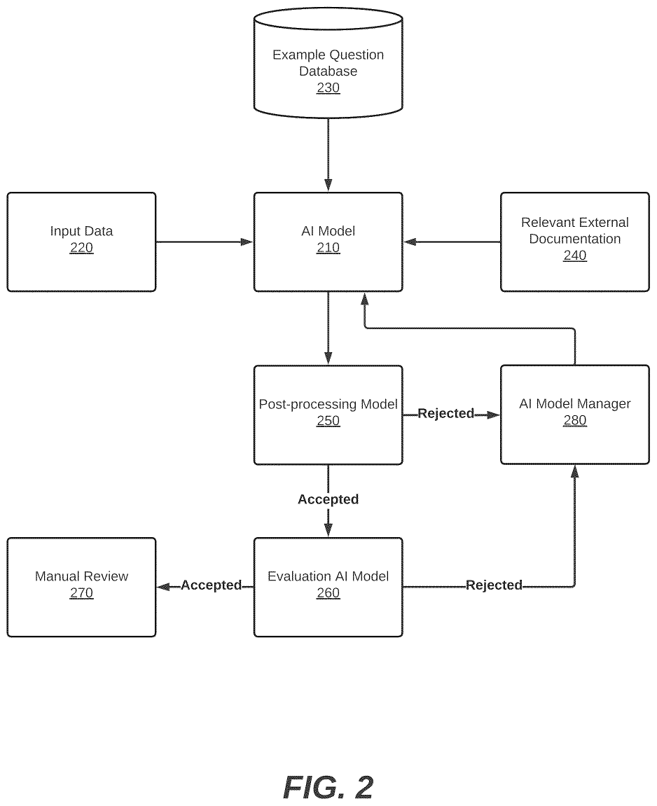

Example implementations of the method are described in more detail with respect to FIGS. 1-2.

### 1. Method for Generating Assessment Questions Automatically

FIG. 1 illustrates a method for generating assessment questions automatically. The system receives input data related to a user-specified topic, where the input data includes a user-specified learning objective (step 110). The system generates a set of MCQs based on the received input data using an AI model (step 120). In certain embodiments, the AI model is a pre-trained model.

The system analyzes the generated MCQs for errors using the AI model by detecting and discarding generated MCQs having problematic distractors, and ensuring compliance with formatting standards (step 130). A distractor is an incorrect answer choice. For example, if the correct answer to a MCQ having options A, B, C, and D is “B,” then A, C, and D are distractors. A problematic distractor is an answer choice that is obviously an incorrect answer and can be easily eliminated. In certain embodiments, problematic distractors include distractors that do not satisfy length criteria, which is correlated with complexity, or difficulty criteria. For example, if the correct answer is longer and much more detailed than the other answer choices, this would be detected and discarded as a problematic distractor. In certain embodiments, this would be determined by computing the variance in length between the different answer options. If the variance is above a threshold, the system discards the answer option. In addition, if the feedback in the MCQ explicitly states whether the answer choices are correct or incorrect, this too would be detected and discarded as a problematic distractor. The feedback should only contain the rationale behind the choices and not explicitly state whether a choice is correct or incorrect. If an answer choice indicates that something should be done manually or randomly, this would also be detected and discarded as a problematic distractor. Ensuring compliance with formatting standards includes properly formatting the coding questions, including the required backticks in the coding questions, and creating questions that can be clearly understood, do not contain bias, and are inclusive (e.g., understandable for those with impairments).

The system evaluates the generated MCQs for alignment with the user-specified learning objective and adherence to predefined quality criteria using an evaluation AI model (step 140). The generated MCQs are evaluated as accepted or rejected. The system discards any generated MCQs evaluated as rejected by the evaluation AI model (step 150). The system determines whether there are a target number of generated MCQs evaluated as accepted by the evaluation AI model (step 160). In response to having less than the target number of generated MCQs evaluated as accepted, the system repeats the generation, analysis, and evaluation processes until there are a target number of generated MCQs evaluated as accepted (step 170).

The system outputs the target number of generated MCQs evaluated as accepted by the evaluation AI Model (step 180). In certain embodiments, the target number of generated MCQs are outputted for storage in a database, where the MCQs can be later retrieved for manual review or for use in an assessment. In certain embodiments, where there is a manual review step, the manual reviewer may use a user interface to open and view the file containing the MCQs. In certain embodiments, where the MCQs are used in an assessment, the assessment taker may view the MCQs through an assessment user interface. In certain embodiments, there is no manual review. Instead, the MCQs are outputted in real time to a computer-based assessment program.

In certain embodiments, the AI model and the evaluation AI model are different due to cost reasons (e.g., the evaluation AI model being more expensive to use since the evaluation AI model is a fine-tuned model trained with positive and negative examples). In certain embodiments, the AI model and the evaluation AI model are the same (e.g., as AI technology develops, one model could perform both functions).

In certain embodiments, the AI model is a large language model (LLM) (e.g., GPT-4) and the evaluation AI model is a fine-tuned LLM that is fine-tuned based on an example set of acceptable and unacceptable MCQs and corresponding reasons. In certain embodiments, the fine-tuned LLM is fine-tuned using a dataset of questions annotated by human reviewers, who construct a training dataset using rejection categories and their explanations for rejected questions, along with accepted questions with no rejection reasons. Using this training dataset, the fine-tuned LLM learns how to assess MCQs, and accept or reject them according to the set of provided guidelines.

In certain embodiments, the input data includes example MCQs (e.g., two example MCQs), and wherein generating the set of MCQs includes training the AI model by inputting the example MCQs and outputting an AI-determined learning objective. The example MCQs conform to the required standards, and help the AI model to understand the concept of a learning objective and connect it with the MCQ.

In certain embodiments, the input data includes a certification/subject, domain, subdomain, and the target number of requested MCQs. For example:
Certification: AWS SysOps
Domain: Deployment, Provisioning, and Automation
SubDomain: Provision and maintain cloud resources
Learning Objective: Provision resources across multiple AWS Regions and accounts (for example, AWS Resource Access Manager, CloudFormation StackSets, IAM cross-account roles)

In certain embodiments, the input data also includes relevant external documents. The purpose is to generate MCQs having a more in-depth level of questions using the additional information. In such embodiments, analyzing the generated MCQs for errors includes detecting and discarding generated MCQs having a similarity score greater than a threshold to the relevant external documents. This is done by comparing the content in the relevant external documents to the MCQs. If a threshold amount of matching n-grams are exceeded, then the MCQs are considered too similar to the relevant external documents. This prevents plagiarism of the relevant external documents.

In certain embodiments, the predefined quality criteria include detecting whether multiple answer choices are correct (i.e., double-keyed), whether an answer choice has a similarity score greater than a threshold to an MCQ stem, and insufficient or unhelpful feedback. To determine whether an answer choice is too similar to an MCQ stem, the answer choice is compared to the MCQ stem. If a threshold amount of matching n-grams are exceeded, then the answer choice is considered too similar to the MCQ stem.

In certain embodiments, the system can be adapted to generate MCQs even if the learning objectives are not already defined by extracting learning objectives from a piece of text. In certain embodiments, the system includes a revision tool, which enables a subject matter expert to analyze the generated MCQs and provide feedback for improving the MCQs. The feedback is sent to the AI model as part of a prompt, and a revised and improved version of the MCQ is returned.

### 2. Example System Architecture and Data Flow

FIG. 2 illustrates an example architecture and data flow for a system that performs the methods described herein. However, the methods described herein may be implemented in other systems and are not limited to the illustrated system.

The AI model 210 receives input data 220 related to a user-specified topic, where the input data 220 includes a user-specified learning objective. The AI model 210 generates a set of MCQs based on the received input data 220. In certain embodiments, the AI model 210 also receives example MCQs from an example question database 230, and generating the set of MCQs includes training the AI model 210 by inputting the example MCQs and outputting an AI-determined learning objective. In certain embodiments, the AI model 210 also receives relevant external documentation 240 to generate MCQs having a more in-depth level of questions using the additional information.

The post-processing model 250 analyzes the generated MCQs for errors using the AI model 210 by detecting and discarding generated MCQs having problematic distractors, and ensuring compliance with formatting standards. If the post-processing model 250 accepts the generated MCQs, the evaluation AI model 260 evaluates the generated MCQs for alignment with the user-specified learning objective and adherence to predefined quality criteria. If a target number of generated MCQs are evaluated as accepted by the evaluation AI model 260, the target number of generated MCQs evaluated as accepted by the evaluation AI model 260 are outputted for storage in a database, for manual review 270, and/or to be used in an assessment program. In response to there being less than the target number of generated MCQs evaluated as accepted by the evaluation AI model 260, the system repeats the generation, analysis, and evaluation processes until there are a target number of generated MCQs evaluated as accepted.

The AI model manager 280 receives rejection information from the post-processing model 250 and the evaluation AI model 260 and provides a feedback loop to the AI model 210 to reinitiate some or all of the processes. In response to either the post-processing model 250 or the evaluation AI model 260 rejecting the generated MCQs, the AI model manager 280 discards the generated MCQs and instructs the AI model 210 to repeat the generation, analysis, and evaluation processes.

### 3. General

The methods described with respect to FIGS. 1-2 are embodied in software and performed by a computer system (comprising one or more computing devices) executing the software. A person skilled in the art would understand that a computer system has one or more memory units, disks, or other physical, computer-readable storage media for storing software instructions, as well as one or more processors for executing the software instructions.

As will be understood by those familiar with the art, the invention may be embodied in other specific forms without departing from the spirit or essential characteristics thereof. Accordingly, the above disclosure is intended to be illustrative, but not limiting, of the scope of the invention, which is set forth in the following claims.

1. A method, performed by a computer system, for generating assessment questions automatically, comprising:
receiving input data related to a user-specified topic, wherein the input data comprises a user-specified learning objective;
generating a set of multiple-choice questions (MCQs) based on the received input data using an AI model;
analyzing the generated MCQs for errors using the AI model by:
detecting and discarding generated MCQs having problematic distractors, wherein problematic distractors include distractors that do not satisfy length or difficulty criteria, and
ensuring compliance with formatting standards;
evaluating the generated MCQs for alignment with the user-specified learning objective and adherence to predefined quality criteria using an evaluation AI model, wherein the generated MCQs are evaluated as accepted or rejected;
discarding any generated MCQs evaluated as rejected by the evaluation AI model;
determining whether there are a target number of generated MCQs evaluated as accepted by the evaluation AI model;
in response to having less than the target number of generated MCQs evaluated as accepted, repeating the generation, analysis, and evaluation processes until there are a target number of generated MCQs evaluated as accepted; and
outputting the target number of generated MCQs evaluated as accepted by the evaluation AI model.

2. The method of claim 1, wherein the AI model is an LLM and the evaluation AI model is a fine-tuned LLM that is fine-tuned based on an example set of acceptable and unacceptable MCQs and corresponding reasons.

3. The method of claim 1, wherein the input data comprises example MCQs, and wherein generating the set of MCQs comprises training the AI model by inputting the example MCQs and outputting an AI-determined learning objective.

4. The method of claim 1, wherein the input data comprises a certification/subject, domain, subdomain, and the target number of requested MCQs.

5. The method of claim 4, wherein the input data also comprises relevant external documents, and wherein analyzing the generated MCQs for errors also comprises detecting and discarding generated MCQs having a similarity score greater than a threshold to the relevant external documents.

6. The method of claim 1, wherein the predefined quality criteria comprise detecting whether multiple answer choices are correct, whether an answer choice has a similarity score greater than a threshold to an MCQ stem, and insufficient or unhelpful feedback.

7. A non-transitory computer-readable medium comprising a computer program, that, when executed by a computer system, enables the computer system to perform the following steps for generating assessment questions automatically, the steps comprising:
receiving input data related to a user-specified topic, wherein the input data comprises a user-specified learning objective;
generating a set of multiple-choice questions (MCQs) based on the received input data using an AI model;
analyzing the generated MCQs for errors using the AI model by:
detecting and discarding generated MCQs having problematic distractors, wherein problematic distractors include distractors that do not satisfy length or difficulty criteria, and
ensuring compliance with formatting standards;
evaluating the generated MCQs for alignment with the user-specified learning objective and adherence to predefined quality criteria using an evaluation AI model, wherein the generated MCQs are evaluated as accepted or rejected;
discarding any generated MCQs evaluated as rejected by the evaluation AI model;
determining whether there are a target number of generated MCQs evaluated as accepted by the evaluation AI model;
in response to having less than the target number of generated MCQs evaluated as accepted, repeating the generation, analysis, and evaluation processes until there are a target number of generated MCQs evaluated as accepted; and
outputting the target number of generated MCQs evaluated as accepted by the evaluation AI model.

8. The non-transitory computer-readable medium of claim 7, wherein the AI model is an LLM and the evaluation AI model is a fine-tuned LLM that is fine-tuned based on an example set of acceptable and unacceptable MCQs and corresponding reasons.

9. The non-transitory computer-readable medium of claim 7, wherein the input data comprises example MCQs, and wherein generating the set of MCQs comprises training the AI model by inputting the example MCQs and outputting an AI-determined learning objective.

10. The non-transitory computer-readable medium of claim 7, wherein the input data comprises a certification/subject, domain, subdomain, and the target number of requested MCQs.

11. The non-transitory computer-readable medium of claim 10, wherein the input data also comprises relevant external documents, and wherein analyzing the generated MCQs for errors also comprises detecting and discarding generated MCQs having a similarity score greater than a threshold to the relevant external documents.

12. The non-transitory computer-readable medium of claim 7, wherein the predefined quality criteria comprise detecting whether multiple answer choices are correct, whether an answer choice has a similarity score greater than a threshold to an MCQ stem, and insufficient or unhelpful feedback.

13. A computer system for generating assessment questions automatically, the system comprising:
one or more processors;
one or more memory units coupled to the one or more processors, wherein the one or more memory units store instructions that, when executed by the one or more processors, cause the system to perform the operations of:
receiving input data related to a user-specified topic, wherein the input data comprises a user-specified learning objective;
generating a set of multiple-choice questions (MCQs) based on the received input data using an AI model;
analyzing the generated MCQs for errors using the AI model by:
detecting and discarding generated MCQs having problematic distractors, wherein problematic distractors include distractors that do not satisfy length or difficulty criteria, and
ensuring compliance with formatting standards;
evaluating the generated MCQs for alignment with the user-specified learning objective and adherence to predefined quality criteria using an evaluation AI model, wherein the generated MCQs are evaluated as accepted or rejected;
discarding any generated MCQs evaluated as rejected by the evaluation AI model;
determining whether there are a target number of generated MCQs evaluated as accepted by the evaluation AI model;
in response to having less than the target number of generated MCQs evaluated as accepted, repeating the generation, analysis, and evaluation processes until there are a target number of generated MCQs evaluated as accepted; and
outputting the target number of generated MCQs evaluated as accepted by the evaluation AI model.

14. The computer system of claim 13, wherein the AI model is an LLM and the evaluation AI model is a fine-tuned LLM that is fine-tuned based on an example set of acceptable and unacceptable MCQs and corresponding reasons.

15. The computer system of claim 13, wherein the input data comprises example MCQs, and wherein generating the set of MCQs comprises training the AI model by inputting the example MCQs and outputting an AI-determined learning objective.

16. The computer system of claim 13, wherein the input data comprises a certification/subject, domain, subdomain, and the target number of requested MCQs.

17. The computer system of claim 16, wherein the input data also comprises relevant external documents, and wherein analyzing the generated MCQs for errors also comprises detecting and discarding generated MCQs having a similarity score greater than a threshold to the relevant external documents.

18. The computer system of claim 13, wherein the predefined quality criteria comprise detecting whether multiple answer choices are correct, whether an answer choice has a similarity score greater than a threshold to an MCQ stem, and insufficient or unhelpful feedback.
